(19) United States
(12) Patent Application Publication
(10) Pub. No.: US 2023/0107223 A1
(43) Pub. Date: Apr. 6, 2023

(54) ELECTRIC TACO GRILLER

(71) Applicant: Xavier G. Gonzalez, Mesa, AZ (US)

(72) Inventor: Xavier G. Gonzalez, Mesa, AZ (US)

(21) Appl. No.: 17/491,635

(22) Filed: Oct. 1, 2021

(51) Int. Cl. A47J 37/06; H05B 3/68

(52) U.S. Cl. CPC A47J 37/0611; H05B 3/68

(57) ABSTRACT

A food heating appliance primarily directed for cooking tacos comprises a frame, a heating element assembly connected to the frame, and a grill panel connected to the frame. The grill panel has an articulated form which defines several spaced apart troughs with trough having a bottom portion at a bottom level and a top portion at a top level above the bottom level. In various preferred embodiments, the grill panel articulated only on one axis so that each trough has a constant cross section, and has opposed upper portions at the top level. The grill surface panel may be an integral sheet of metal. A heating element assembly has heating elements with elevated, downward arcing portions above the bottom level and at an intermediate level above the bottom level and below the top level of the troughs. The elevated portions of the heating elements are spaced between the troughs.

### FIELD OF THE INVENTION

The present invention relates to small appliances for cooking or heating foods, especially tacos or foods having a similar cross sectional shape as a taco.

### BACKGROUND AND SUMMARY

Cooking tacos according to traditional methods typically involves pan-frying corn or soft tortilla discs in oil, turning them over so both sides cook evenly in the oil, and then curling them up at just the right moment to form crunchy, semi-circular shells having spaced apart lobes. While partially cooked, the upper lobe must be supported at a desired spacing from the lower lobe, and cooking proceeds unevenly with the lower lobe immersed in oil while the upper lobe remains in air above the oil. The taco shell must be flipped over in the oil a number of times until both lobes are cooked evenly and completely. This process is time-consuming and it is difficult for home cooks or other non-professionals to produce pleasingly uniform results wherein a set of fried taco shells contain reasonably similar volumes of food fillings.

Also, foods made by deep frying soft tortillas in oil are high in calories. Taco shells made by traditional methods immerse the soft tortillas in oil for several minutes at a time and thus they absorb a lot of oil. People minding their calorie intake would prefer tacos made by other methods than immersing the taco shell in fry oil.

There is also a desire for convenience in food preparation, so that processes requiring multiple steps using multiple cooking tools can be consolidated to fewer steps and tools, or a single step or tool.

The above disadvantages are addressed by providing an electric taco griddle as a convenient food heating appliance which comprises a heating element assembly and a grill panel both connected to a frame. The grill panel has an articulated form to define spaced apart troughs, with heating elements within the frame which bestride the troughs at an intermediate level above the bottom level and below the top level of the troughs. The articulated grill panel shapes flat membranes of soft tortillas into tacos, and the heating elements cook them and the taco fillings in place.

### BRIEF DESCRIPTION OF THE DRAWINGS

FIG. 1a shows an oblique view of a food heating appliance and a taco.

FIG. 1b shows a top view of the food heating appliance of FIG. 1a, defines section line A-A for the cross section view of FIG. 4, and defines section line B-B for the cross section view of FIG. 5.

FIG. 2 shows an oblique, exploded view of components of the food heating appliance of FIG. 1a.

FIG. 3 shows a heating element subassembly for the food heating appliance of FIG. 1a.

FIG. 4 shows a cross section of the food heating appliance of FIG. 1a taken at section line A-A of FIG. 1b.

FIG. 5 shows a cross section of the food heating appliance of FIG. 1a taken at section line B-B of FIG. 1b, and a taco being cooked by the food heating appliance.

### DETAILED DESCRIPTION OF A PREFERRED EMBODIMENT

The invention is an electric taco griddle which in a typical embodiment cooks two soft tortillas at once to make taco shells in paired troughs of a “W” shaped grilling surface, and may be used to prepare tacos with fillings heated by the appliance. Compared to traditional deep frying or pan frying methods, the griddle allows taco shells to be toasted to crispy firmness while using little to no cooking oils or grease. Reducing oil content of foods reduces their calorie content, so tacos produced using the present invention may be healthier for eating than traditional high-calorie tacos.

The griddle surface is removable from the frame of the appliance for easy cleaning. Compared to pan frying methods or other methods which require time to heat a volume of oil up to cooking temperature, the electrically heated grilling surface achieves desired cooking temperatures within a few minutes, and eliminates extra time and logistics spent to cool down and re-store used cooking oil after cooking is finished. Ideally, cold ingredients such a tortilla, cheese, and precooked meat may be assembled and cooked in a single step, and these may even be provided in prepackaged form, with fresh ingredients such as lettuce and tomatoes added after heating. The appliance is conveniently sized for home use.

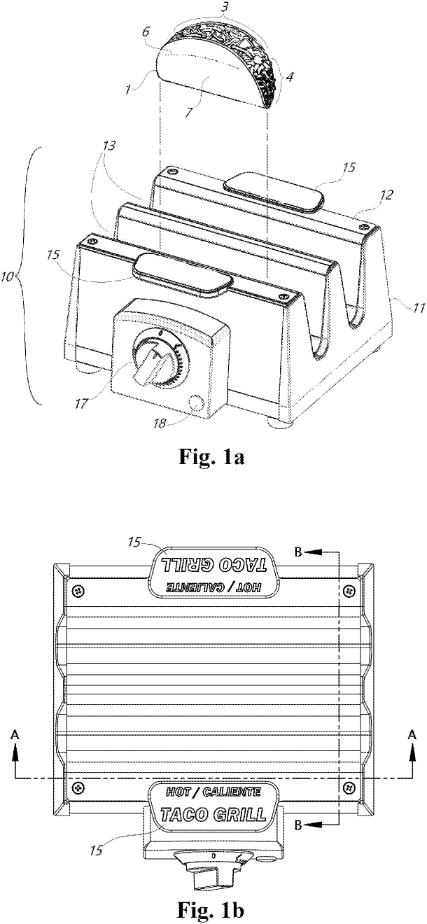

FIG. 1a shows an oblique view of a food heating appliance [10] and a taco [1.] Tacos are often assembled up with fluffier fillings [3] such as shredded cheese or shredded lettuce in an upper portion above an arbitrary line [6,] with denser fillings [4] having higher specific heats, such as ground meats and refried beans ending up in the lower portion [7] of the taco. As will be seen in the following figures, the arched shape of the heating elements of the invention advantageously concentrates more heat into cooking the denser portion of the taco.

As a food heating appliance, the electric taco griddle uses an electric temperature controller to easily adjust the cook temperature and cook the tacos to a crispy finish. The grill panel [12] has an articulated form to define a plurality of spaced apart troughs [13] and connects to or is received into a frame [11.] For convenience in removing and replacing the grill panel within the frame, thermally non-conductive handles [15] are affixed to opposed upper portions of the frame. According to variants within the scope of the invention, a pilot light [18] may be electrically wired to indicate power available (unit plugged in,) or power “on” (heating elements are energized) or that the grill surfaces are hot enough for cooking, or remain hot as a hazard. A preferred embodiment uses a temperature controller with a knob [17] including pointer and a bezel with indicia for a range of cooking temperatures, and another variant uses a timer and a bezel indicating cooking minutes remaining as an internal timing mechanism returns the knob to a “power off” condition.

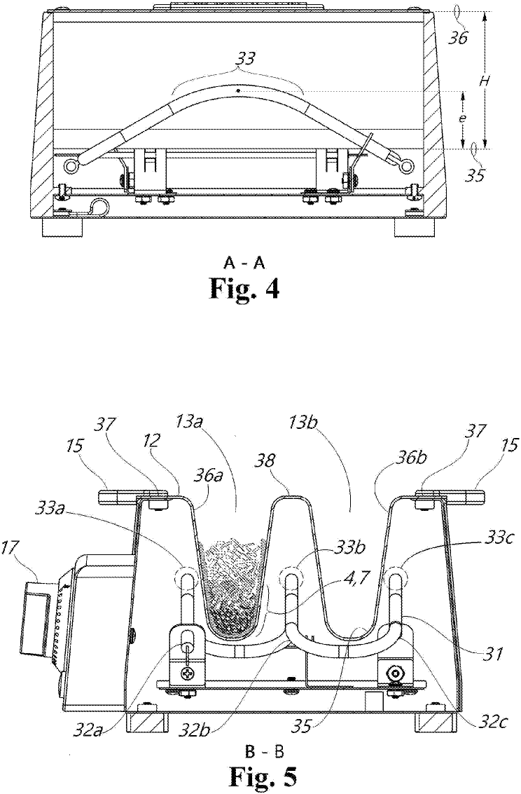

FIG. 1b shows a top view of the food heating appliance of FIG. 1a, defines section line A-A for the cross section view of FIG. 4, and defines section line B-B for the cross section view of FIG. 5. In this view the handles [15] include exemplary indicia such as a brand name or logo and warning texts for the hot surfaces of the grill troughs. The handles may preferably be made of thermally non-conducting materials so that even a hot grill panel may be conveniently removed, cleaned and replaced within the frame.

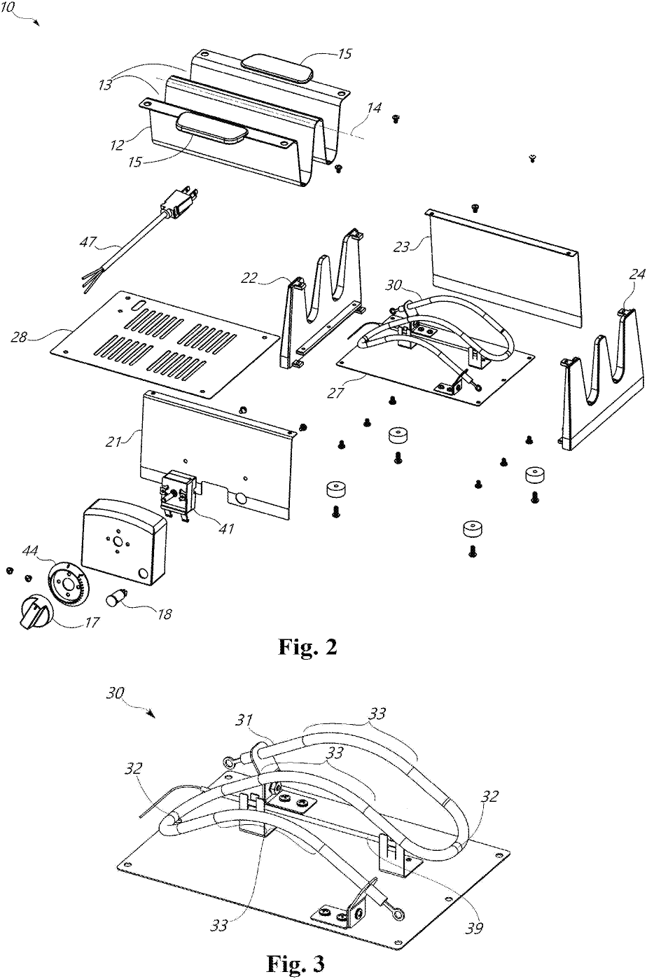

FIG. 2 shows an oblique, exploded view of components of the food heating appliance [10] of FIG. 1a. The appliance includes a frame comprised of a front panel [21,] a left side panel [22,] a back panel [23,] a right side panel [24,] and a louvered bottom cover [28.] A front console assembly includes a temperature controller [41,] a knob [17] attached to a control shaft of the controller, a bezel [44] having indicia such as “0” for power off or to indicate “cooking time has elapsed,” and a range of indicia for cooking temperatures or cooking time. A heating element assembly [30] is connected to the frame and includes a plurality of arched heating elements and a mid-mount plate [27] which may also act as a heat shield or a heat reflector.

The grill panel [12] of the food heating appliance of is preferably articulated only on one axis [14] so that it has a constant cross section over its length and the longitudinal axes of the troughs are substantially parallel. In this embodiment the grill surface panel is an integral sheet of metal, with handles [15] for lifting it out of the frame for convenient cleaning. Another variant may have the grill permanently attached to the frame and the handles available for lifting and positioning the entire appliance. The appliance assembly also includes a power cord [47] wired to the temperature controller and the heating elements.

FIG. 3 shows a heating element subassembly [30] for the food heating appliance of FIG. 1a which includes a heating element [31] having a plurality of arched coil heating elements used to heat the taco griddle pan which is complementary to the contoured “W” form of the sheet metal grill. 14. The arched portions of the heating element are oriented parallel to the troughs in the grill. Each arch portion includes ends at a low elevation and an elevated medial portion which includes a concave downward arc [33.] The ends of the arched portions are connected by connecting portions [32] to electrically join the arched sections. In the embodiment shown, the heating element is a single continuous element having at least one connecting portion [32] below the bottom level interconnecting the elevated portions. The connecting portions are also heat-generating portions and the arched portions are connected in series. It is also within the scope of the invention that the connecting portions which are conductors which do not produce heat for cooking, and also that the arched portions may also be electrically connected in parallel. A temperature sensor [39] is located near a portion of the heating element and connected to a thermostat to control its operating temperature. The heating element, sensor, and wiring are secured to the mid-mount plate by clips.

FIG. 4 shows a cross section of the food heating appliance of FIG. 1a taken at section line A-A of FIG. 1b. Each trough of the griddle or grill has a bottom portion at a bottom level [35,] and a top portion at a top level [36] at a height [H] above the bottom level. Arched portions of the heating elements oriented parallel to the troughs each have a medial portion [33] which is a first elevated portion elevated at an intermediate level [e] above the bottom level and below the top level of the troughs.

FIG. 5 shows a cross section of the food heating appliance of FIG. 1a taken at section line B-B of FIG. 1b, and a taco being cooked by the food heating appliance. Grill panel [12] forms a “W” shape defining a pair of adj acent troughs and which each have a constant cross section. The heating element includes arched portions with their elevated portions disposed alongside the troughs and on opposed sides of each trough, so that these elevated portions heat the trough sidewalls of the W-shaped griddle. Additional heat is also imparted to the bottoms of the troughs such as by conduction within the grill material down from the walls and also by convection or radiation from the connecting portions between the arched portions which pass below the bottoms of the troughs.

Each trough has a bottom portion at a bottom level [35,] and a top portion at a top level above the bottom level. Each trough also has opposed upper portions at the top level. Additional heat is transferred by convection from the heating elements to the top levels of the troughs. The first and last portions of the top level [37] include handles [15,] preferably made of a thermally non-conducting material, for lifting the grill out of the appliance frame for cleaning. For a variant where the grill is permanently attached to the frame, the handles serve as lifting affordances for the entire appliance.

The heating element assembly has a plurality of elevated portions above the bottom level. In the example embodiment shown, a first elevated portion [33b] is disposed between the troughs[13a] and [13b.] A second elevated portion [33a] is adjacent to a first one of the troughs [13a] opposite the first elevated portion, and a third elevated portion [33c] is adjacent to a second one of the troughs [13b] opposite the first elevated portion. Each trough has an associated elevated portion on opposite sides of the trough; in the example shown the first trough [13a] has elevated portions [33a] and [33b] on opposite sides of it, and the second trough [13b] has elevated portions [33b] and [33c] on opposite sides of it. Each elevated portion of the heating element has end portions below the bottom level of the troughs and an intermediate portion elevated above the bottom level.

With this example embodiment having two troughs and the heating elements having three elevated portions. It is also possible to create a food heating appliance having more articulated sections defining more troughs, and in heating both sides of the total number of troughs it will be understood that the number of elevated portions will be greater by one than the number of troughs. The troughs have a constant cross section and the entire grill panel also has constant cross-sectional profile.

Many modifications and variations on the present disclosure may be made and other methods performed without departing from its spirit and scope. For example, the appliance may also be used for making flautas without deep frying. To make flautas, a user may partially cook tortillas in the heated troughs of the device, remove them to add meats and other fillings, roll the partially cooked shells to close them over the fillings and then replace the filled tortilla tubes in the heated troughs to cook until crispy. Flautas made using this appliance and method will contain much less oil than traditionally prepared fare and allow calorie conscious people to continue to enjoy these foods.

Also, hot dog buns when grilled are usually split open and buttered on the interior surfaces which are then hinged apart 180° and pressed onto a flat grilled surface. This process disadvantageously weakens the bread at this hinge, often allowing the halves to split apart. By using the inventive grilling appliance, split and buttered hot dog buns may be placed inverted over the ridge between adjacent troughs, which hold them open to an angle much less than 180° during cooking. The appliance may be used for simultaneously cooking the wiener or sausage in one adjacent trough and other heatable toppings such as chopped onions for grilling in the other trough.

The special shape of the cooking surfaces may also be amenable to cooking other deep fried tube foods such as Asian egg rolls, crispy spring rolls, or other lenticular foods, and may inspire entirely new food creations. Thus, although many exemplary embodiments are described above, it will be appreciated that the invention is intended to cover all modifications and equivalents within the scope of the following claims.

I claim:

1. A food heating appliance comprising:
a frame;
a heating element assembly connected to the frame;
a grill panel connected to the frame;
the grill panel having an articulated form to define a plurality of spaced apart troughs;
each trough having a bottom portion at a bottom level, and a top portion at a top level above the bottom level; and
the heating element assembly having a heating element portion at an intermediate level above the bottom level and below the top level.

2. The food heating appliance of claim 1, wherein the panel has a W shape defining a pair of adj acent troughs.

3. The food heating appliance of claim 1, wherein each trough has a constant cross section.

4. The food heating appliance of claim 1, wherein each trough has opposed upper portions at the top level.

5. The food heating appliance of claim 1, wherein the grill surface panel is an integral sheet of metal.

6. The food heating appliance of claim 1, wherein the heating element assembly has a plurality of elevated portions above the bottom level.

7. The food heating appliance of claim 6, wherein a first elevated portion is between the troughs.

8. The food heating appliance of claim 6, wherein a second elevated portion is adjacent to a first one of the troughs opposite the first elevated portion, and a third elevated portion is adjacent to a second one of the troughs opposite the first elevated portion.

9. The food heating appliance of claim 6 wherein the heating element has an elevated portion on opposed sides of each trough.

10. The food heating appliance of claim 6, wherein the heating element has a first elevated portion.

11. The food heating appliance of claim 6, wherein each trough has an associated elevated portion on opposite sides of the trough.

12. The food heating appliance of claim 6, wherein the number of elevated portions is greater by one than the number of troughs.

13. The food heating appliance of claim 6, wherein the heating element is a single continuous element having at least a connecting portion below the bottom level and interconnecting the elevated portions.

14. The food heating appliance of claim 6, wherein each elevated portion is a concave downward arc.

15. The food heating appliance of claim 6, wherein each elevated portion has end portions below the bottom level and an intermediate portion above the bottom level.

16. The food heating appliance of claim 1, wherein the grill panel is articulated only on one axis.

17. The food heating appliance of claim 1, wherein the grill panel has a constant cross-sectional profile.
